(19) United States
(12) Patent Application Publication
(10) Pub. No.: US 2023/0410527 A1
(43) Pub. Date: Dec. 21, 2023

(54) ROADWHEEL ANGLE ESTIMATION BASED ON CAMERA INPUT

(71) Applicants: Steering Solutions IP Holding Corporation, Auburn Hills, MI (US); Continental Automotive Systems, Inc., Auburn Hills, MI (US)

(72) Inventor: Omkar Karve, Farmington Hills, MI (US)

(21) Appl. No.: 17/844,304

(22) Filed: Jun. 20, 2022

(51) Int. Cl. G06V 20/56; B62D 15/02; B60R 1/12; B60C 11/24; B60R 11/04; G07C 5/08; G01B 11/26

(52) U.S. Cl. CPC G06V 20/56; B62D 15/021; B60R 1/12; B60C 11/246; B60R 2011/004; B62D 15/0225; G07C 5/0808; G01B 11/26; B60R 2001/1253; B60R 11/04

(57) ABSTRACT

A number of variations may include a vehicle, system and method of estimating roadwheel angle based on camera input. A number of variations may include at least one of camera based angle detection of roadwheels; tire alignment problem detection using available cameras; or detection of gross roadwheel/tire problems using cameras.

### TECHNICAL FIELD

The field to which the disclosure generally relates to vehicle with systems, which may include a steering rack and/or a steering angle sensor.

### BACKGROUND

Vehicles typically include steering systems.

### SUMMARY OF ILLUSTRATIVE VARIATIONS

A number of variations may include a vehicle, system and method of estimating roadwheel angle based on camera input.

A number of variations may include at least one of camera based angle detection of roadwheels; tire alignment problem detection using available cameras; or detection of gross roadwheel/tire problems using cameras.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a portion of a driver side of a vehicle;

FIG. 2 is a schematic illustration of a passenger side of a vehicle;

FIG. 3 is a schematic illustration of a vehicle and system for estimating roadwheel angle based on camera input.

### DETAILED DESCRIPTION OF ILLUSTRATIVE VARIATIONS

The following description of the variations is merely illustrative in nature and is in no way intended to limit the scope of the invention, its application, or uses.

In case of steering rack failure or failure of SAS (steering angle sensor) embedded elsewhere, a number of variations may provide for an alternate source of estimating the roadwheel angle based on camera input.

When roadwheel angle sensor or steering angle sensor fails various stability, safety systems that need the angle input cannot function optimally and can malfunction. Many vehicles have cameras installed on the underside of the side view mirrors looking down at the curb or road. These cameras have the front roadwheel in sight. The image from these cameras can be used to detect roadwheel angle by analyzing the image. Alternatively, an additional camera that has view of the roadwheel can be used.

If the primary source of road/steering wheel angle detection (such as SAS) fails, a system is activated that starts to read the images from the cameras that have the view of the front steered roadwheels. The system passes the images to an image analysis software that can detect the edges of the roadwheel/tires and estimate the roadwheel angle. This can function as a backup for primary SAS.

The image analysis algorithm may be constructed and arranged to isolate tire profile at all times and detect edges and be able to estimate the steering angle as a correlation of the detected edge angle. The accuracy will be limited by the resolution of the camera and other factors such as presence of mud or the like on the tire walls. If the camera is obscured, this will need to be detected and communicated to functions using this signal from this function. The upstream functions may need to adjust based on resolution of the image obtained and uncertainty related to estimate provided. The algorithm may be constructed and arranged to also provide the uncertainty of the estimate as an input to the functions using the angle estimate.

In addition, if there are two cameras in two side view mirrors, the system can also detect problems with steering system such as misaligned tires or a gross angle problem or problem with the roadwheels.

This can be standard feature in all vehicles that have cameras with view of the front steered roadwheels. This can also be offered as an additional function with dedicated cameras.

A number of variations may include at least one of camera based angle detection of roadwheels; tire alignment problem detection using available cameras; or detection of gross roadwheel/tire problems using cameras.

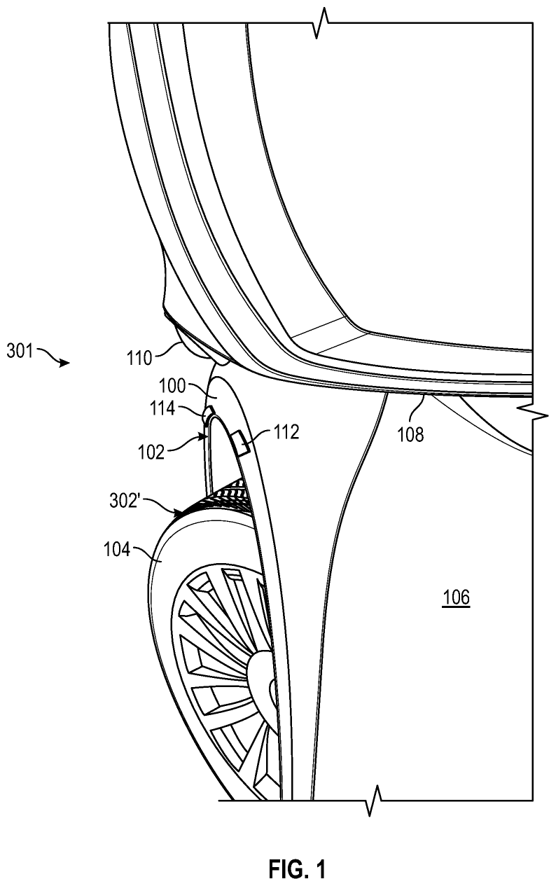

FIG. 1 illustrates the front portion the driver side of a vehicle 301. The vehicle 301 may include a driver side front quarter panel 100 and an adjacent driver side door panel 106 and a side view mirror 108 attached to the driver side 106. A side view mirror camera 110 is attached to the side view mirror 108 attached to the driver side door 106. The vehicle may include a driver side steerable roadwheel or tire 302′ having a sidewall 104. The side view mirror camera 110 is attached to the side view mirror 108 attached to the driver side door 106 Is constructing and arranged to record data regarding the position of the driver side steerable roadwheel 302′. The steering angle can be determined and a variety of different ways including, but not limited to displacement of the driver side steerable roadwheel 104 from a position inside of the driver side wheel well 102 when the vehicle is traveling in a straight forward direction. In another variation, the steering angle may be determined Determining how much of the driver side steerable roadwheel sidewall 104 is visible to the camera attached to the side view mirror 108 on the driver side. In addition to or as an alternative a camera may be position on the driver side front quarter panel 100 above the roadwheel 302′ with a view toward the ground or a camera 114 may be positioned on the driver side front quarter panel 100 in front the roadwheel 302′ with a view toward the rear of the vehicle and in a direction opposite the forward moving direction of the vehicle.

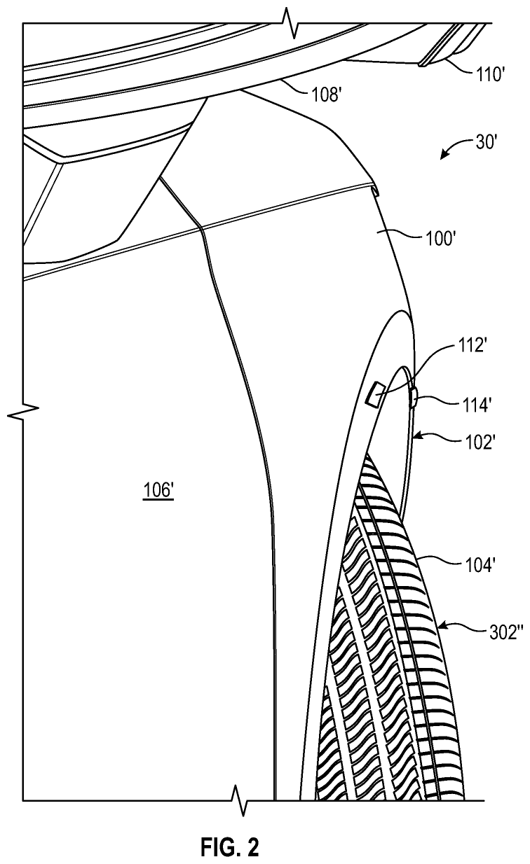

FIG. 2 illustrates the front portion the passenger side of a vehicle 301. The vehicle 301 may include a passenger side front quarter panel 100′ and an adjacent passenger side door panel 106′ and a side view mirror 108′ attached to the passenger side 106′. A side view mirror camera 110′ is attached to the side view mirror 108′ attached to the passenger side door 106. The vehicle may include a passenger side steerable roadwheel or tire 302′ having a sidewall 104′. The side view mirror camera 110′ is attached to the side view mirror 108′ attached to the passenger side door 106′ is constructing and arranged to record data regarding the position of the passenger side steerable roadwheel 302″. The steering angle can be determined and a variety of different ways including, but not limited to displacement of the passenger side steerable roadwheel 104 from a position inside of the passenger side wheel well 102′ when the vehicle is traveling in a straight forward direction. In another variation, the steering angle may be determined determining how much of the driver side steerable roadwheel sidewall 104′ is visible to the camera attached to the side view mirror 108 on the driver side. In addition to or as an alternative a camera may be position on the driver side front quarter panel 100 above the roadwheel 302′ with a view toward the ground or a camera 114 may be positioned on the driver side front quarter panel 100 in front the roadwheel 302′ with a view toward the rear of the vehicle and in a direction opposite the forward moving direction of the vehicle.

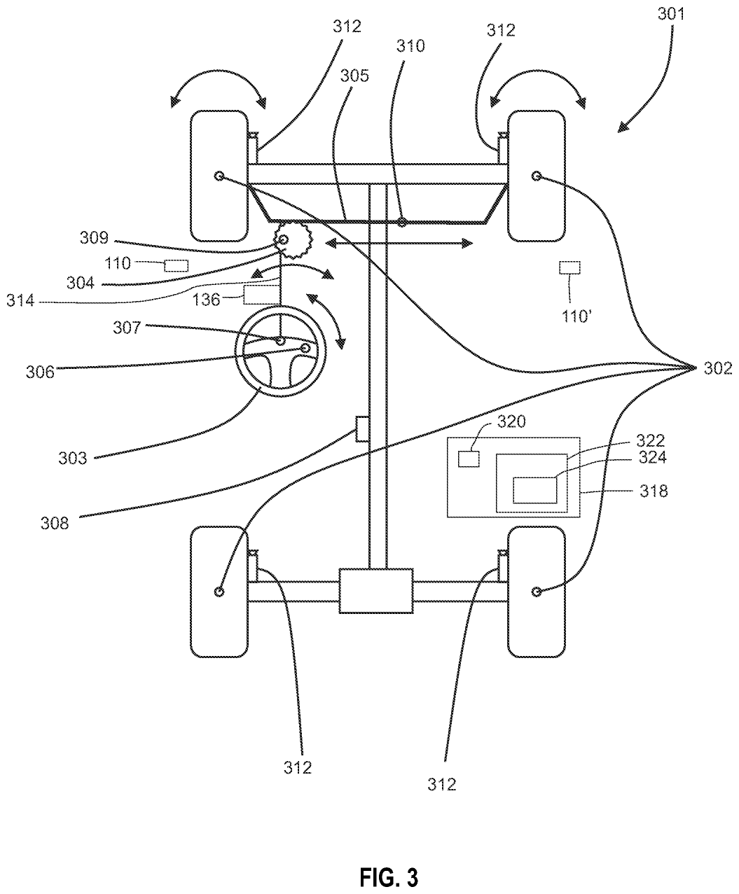

Referring now to FIG. 3, an illustrative variation of a vehicle equipped with hardware that allows it to carry out at least some of the methods disclosed herein is shown. A vehicle 301 is equipped with roadwheels 302 and a handwheel 303 for turning the roadwheels 302 via a pinion 304 that engages a rack 305 that is constructed and arranged to turn the roadwheels 302. In the illustrative variation shown, the handwheel 303 is equipped with a hand wheel torque sensor 306 and a hand wheel angle sensor 307 so that any turning of the handwheel may produce sensor data that may be communicated to or accessed by a controller 308. Although, in this illustrative variation, the controller 308 is shown onboard the vehicle, the controller may also be located somewhere apart from the vehicle and communicated with wirelessly by the sensors or the vehicle. The pinion 304 may be equipped with a pinion torque sensor 309 so that any turning of the pinion may be observed by or communicated to the controller 308 and utilized by the methods described herein. In the illustrative variation shown, the rack 305 is equipped with a rack force sensor 310 so that any rack forces detected during driving may be observed by or communicated to the controller 308 and utilized by the methods described herein. The vehicle may have a steering shaft 314 connecting the steering wheel or steering interface 303 to the pinion 304. An electric power steering assist or hydraulic power steering device 316 may be connected to the shaft 314 to assist the drive in steering the roadwheels of the vehicle by reduce the force or torque the driver would need to apply to the steering wheel or steering interface 304 if the power steering device 316 was not present. Also shown in this illustrative variation, the roadwheels 302 may be equipped with roadwheel sensors so that any roadwheel data detected during driving may be observed by or communicated to the controller 308 and utilized by the methods described herein. Additionally, in the illustrative variation shown, cameras 312 are located near the roadwheels 302, though at least one of the cameras 312 may be located elsewhere in other illustrative variations. The cameras 312 may be used in conjunction with any sensor on the vehicle 301 that aids in monitoring vehicle travel or usage data at least for the purposes of the methods described herein. Another controller 318 may be provided and may include a processor 320, memory 322, wherein the instructions 324 stored in the memory 322 are executable by the processor 320 to determine if the hand wheel angle sensor 307 or if the pinion 304, rack 305, pinion sensor 309, or rack sensor 310 have failed. The instructions 324 stored in the memory 322 may include image analysis algorithm may be constructed and arranged to isolate tire profile at all times and detect edges and be able to estimate the steering angle as a correlation of the detected edge angle. The image analysis algorithm may also be constructed and arranged to determine if the steerable roadwheels 302′, 302″ are out of alignment, or if there is excessive ware of damage to the roadwheels. The cameras 110, 112, 114, 101′, 112′, 114′ may also include infra-red capabilities that may be used to determine the roadwheel position and thereby estimate the steering angle of the roadwheels. Heat from gas in the roadwheel may be visible with the infra-red capable camera. In a number of variations, the roadwheels 302′, 302″ may include tags in the sidewalls 104, 104′ that may be excited to give off heat or a signal.

Variation 1 may include a system comprising at least one processor, memory, instruction stored in the memory and executable by the processor to: receive visual or infrared data regarding a steerable roadwheel of a vehicle from a camera attached to a vehicle component; analyze the data; determine from the analyzed data at least one of the steering angle of the steerable roadwheel, the alignment of the steerable roadwheel, or excessive wear or damage to the steerable roadwheel.

Variation 2 may include a system as set forth in variation 1 wherein the vehicle component is a side view mirror of the vehicle.

Variation 3 may include a system as set forth in variation 1 wherein the vehicle component is a front quarter panel of the vehicle and the camera is attached to the front quarter panel at a position in front of the steerable roadwheel.

Variation 4 may include a system as set forth in variation 1 wherein the vehicle component is a front quarter panel of the vehicle and the camera is attached to the front quarter panel at a position in front of the steerable roadwheel.

Variation 5 may include a system as set forth in variation 1 wherein the vehicle component is a front quarter panel of the vehicle and the camera is attached to the front quarter panel at a position above of the steerable roadwheel.

Variation 6 may include a system as set forth in variation 1 further comprising determine if a steering angle sensor of the vehicle has failed prior to the act of receive visual or infrared data regarding a steerable roadwheel of a vehicle from a camera attached to a vehicle component.

Variation 7 may include a system as set forth in variation 1 further comprising determine if a steering pinion, steering rack, pinion sensor, or rack sensor of the vehicle has failed prior to the act of receive visual or infrared data regarding a steerable roadwheel of a vehicle from a camera attached to a vehicle component.

Variation 8 may include a system as set forth in variation 1 wherein the steering angle is determined by the displacement of a steerable roadwheel of from a position inside a wheel well of the front quarter panel of the vehicle when the vehicle is traveling in a straight forward direction.

Variation 9 may include a system as set forth in variation 1 wherein the steering angle is determined by the area of a sidewall of the steerable roadwheel visible to the camera.

Variation 10 may include a system as set forth in variation 1 wherein the steering angle is determined from infrared data.

Variation 11 may include a method comprising: receiving visual or infrared data regarding a steerable roadwheel of a vehicle from a camera attached to a vehicle component; analyzing the data; determining from the analyzed data at least one of the steering angle of the steerable roadwheel, the alignment of the steerable roadwheel, or excessive wear or damage to the steerable roadwheel.

Variation 12 may include a method as set forth in variation 11 wherein the vehicle component is a side view mirror of the vehicle.

Variation 13 may include a method as set forth in variation 11 wherein the vehicle component is a front quarter panel of the vehicle and the camera is attached to the front quarter panel at a position in front of the steerable roadwheel.

Variation 14 may include a method as set forth in variation 11 wherein the vehicle component is a front quarter panel of the vehicle and the camera is attached to the front quarter panel at a position in front of the steerable roadwheel.

Variation 15 may include a method as set forth in variation 11 wherein the vehicle component is a front quarter panel of the vehicle and the camera is attached to the front quarter panel at a position above of the steerable roadwheel.

Variation 16 may include a method as set forth in variation 11 further comprising determining if a steering angle sensor of the vehicle has failed prior to the act of receive visual or infrared data regarding a steerable roadwheel of a vehicle from a camera attached to a vehicle component.

Variation 17 may include a method as set forth in variation 11 further comprising determining if a steering pinion, steering rack, pinion sensor, or rack sensor of the vehicle has failed prior to the act of receive visual or infrared data regarding a steerable roadwheel of a vehicle from a camera attached to a vehicle component.

Variation 18 may include a method as set forth in variation 11 wherein the steering angle is determined by the displacement of a steerable roadwheel of from a position inside a wheel well of the front quarter panel of the vehicle when the vehicle is traveling in a straight forward direction.

Variation 19 may include a method as set forth in variation 11 wherein the steering angle is determined by the area of a sidewall of the steerable roadwheel visible to the camera.

Variation 20 may include a method as set forth in variation 11 wherein the steering angle is determined from infrared data.

The above description of select variations within the scope of the invention is merely illustrative in nature and, thus, variations or variants thereof are not to be regarded as a departure from the spirit and scope of the invention.

What is claimed is:

1. A system comprising at least one processor, memory, instruction stored in the memory and executable by the processor to:
receive visual or infrared data regarding a steerable roadwheel of a vehicle from a camera attached to a vehicle component;
analyze the data;
determine from the analyzed data at least one of the steering angle of the steerable roadwheel, the alignment of the steerable roadwheel, or excessive wear or damage to the steerable roadwheel.

2. A system as set forth in claim 1 wherein the vehicle component is a side view mirror of the vehicle.

3. A system as set forth in claim 1 wherein the vehicle component is a front quarter panel of the vehicle and the camera is attached to the front quarter panel at a position in front of the steerable roadwheel.

4. A system as set forth in claim 1 wherein the vehicle component is a front quarter panel of the vehicle and the camera is attached to the front quarter panel at a position in front of the steerable roadwheel.

5. A system as set forth in claim 1 wherein the vehicle component is a front quarter panel of the vehicle and the camera is attached to the front quarter panel at a position above of the steerable roadwheel.

6. A system is set forth in claim 1 further comprising determine if a steering angle sensor of the vehicle has failed prior to the act of receive visual or infrared data regarding a steerable roadwheel of a vehicle from a camera attached to a vehicle component.

7. A system is set forth in claim 1 further comprising determine if a steering pinion, steering rack, pinion sensor, or rack sensor of the vehicle has failed prior to the act of receive visual or infrared data regarding a steerable roadwheel of a vehicle from a camera attached to a vehicle component.

8. A system a set forth in claim 1 wherein the steering angle is determined by the displacement of a steerable roadwheel of from a position inside a wheel well of the front quarter panel of the vehicle when the vehicle is traveling in a straight forward direction.

9. A system a set forth in claim 1 wherein the steering angle is determined by the area of a sidewall of the steerable roadwheel visible to the camera.

10. A system as set forth in claim 1 wherein the steering angle is determined from infrared data.

11. A method comprising:
receiving visual or infrared data regarding a steerable roadwheel of a vehicle from a camera attached to a vehicle component;
analyzing the data;
determining from the analyzed data at least one of the steering angle of the steerable roadwheel, the alignment of the steerable roadwheel, or excessive wear or damage to the steerable roadwheel.

12. A method as set forth in claim 1 wherein the vehicle component is a side view mirror of the vehicle.

13. A method as set forth in claim 1 wherein the vehicle component is a front quarter panel of the vehicle and the camera is attached to the front quarter panel at a position in front of the steerable roadwheel.

14. A method as set forth in claim 1 wherein the vehicle component is a front quarter panel of the vehicle and the camera is attached to the front quarter panel at a position in front of the steerable roadwheel.

15. A method as set forth in claim 1 wherein the vehicle component is a front quarter panel of the vehicle and the camera is attached to the front quarter panel at a position above of the steerable roadwheel.

16. A method is set forth in claim 1 further comprising determining if a steering angle sensor of the vehicle has failed prior to the act of receive visual or infrared data regarding a steerable roadwheel of a vehicle from a camera attached to a vehicle component.

17. A method is set forth in claim 1 further comprising determining if a steering pinion, steering rack, pinion sensor, or rack sensor of the vehicle has failed prior to the act of receive visual or infrared data regarding a steerable roadwheel of a vehicle from a camera attached to a vehicle component.

18. A method a set forth in claim 1 wherein the steering angle is determined by the displacement of a steerable roadwheel of from a position inside a wheel well of the front quarter panel of the vehicle when the vehicle is traveling in a straight forward direction.

19. A method a set forth in claim 1 wherein the steering angle is determined by the area of a sidewall of the steerable roadwheel visible to the camera.

20. A method as set forth in claim 1 wherein the steering angle is determined from infrared data.
